(19) United States
(12) Patent Application Publication
(10) Pub. No.: US 2020/0111460 A1
(43) Pub. Date: Apr. 9, 2020

(54) Modular Guitar Bag

(71) Applicant: KLOS INNOVATIONS, LLC, Provo, UT (US)

(72) Inventor: Ian Klosowiak, Provo, UT (US)

(21) Appl. No.: 16/572,480

(22) Filed: Sep. 16, 2019

Related U.S. Application Data
(60) Provisional application No. 62/731,971, filed on Sep. 16, 2018.

(51) Int. Cl. G10G 7/00

(52) U.S. Cl. CPC G10G 7/005

(57) ABSTRACT

A guitar gig bag with multiple configurations to safely store a guitar that is either assembled or disassembled. When storing a guitar in disassembled mode the neck section of the bag is stuffed into the main storage body and the disassembled neck is stored in a separate sleeve. In the disassembled configuration the complete guitar should easily fit within an airplane's overhead compartment.

### TECHNICAL FIELD

The present disclosure relates generally to a modular guitar bag for safe and convenient transport of an assembled or disassembled guitar with removable neck.

### BACKGROUND

The first historical evidence of a stringed instruments is found on tombs in ancient Egypt. Throughout history and into the present day stringed musical instruments continue to be popular. In the United States artists have used the guitar. Acoustic guitars are particularly popular in genres including Country, Folk, bluegrass and the like.

Acoustic instruments are widely used and admired because of their rich sound created by vibrating strings vibrating air in the resonating chamber. Guitars are played primarily by plucking or strumming. Other instruments, such as the violin, viola, cello and bass use a bow to create different sound based on similar technology. Even a piano operates by a vibrating string combined with a sound board.

Many traditions have arisen through time centered on musical instruments. From religious ceremonies to romanticized campfire sing-a-longs, accompanied vocals play an important part in society. As a result, musicians often want to bring their instruments on their travels. Guitar enthusiasts as well as professionals take their guitars wherever they go. Social media allows people to share talents and make more connections with people from around the world. When musicians make social media connections travel often is centered around traveling to meet new contacts to join in a jam session. In addition, with the improved mobility of electronics people have come to expect improved mobility in their other aspects of their lives including musical instruments.

The guitar is a mobile instrument and as a result, guitarists travel with their guitar. However, a standard guitar is a relatively large instrument and traveling with a guitar poses unique challenges, particularly when traveling by air. Despite laws that permit airline passengers to bring guitars and other instruments on board as a carry-on, as well as airline policies which permit musical instruments to be carry-on baggage, there are too many stories of travels who are required to purchase a second seat, or worse, check their instrument as luggage, only to find it destroyed at the luggage carrousel.

As a result, a new guitar bag is needed which is sized to appear as a normal backpack and is dimensioned to easily fit within the overhead space on an airplane. easily placed in permits a guitar bag to be placed in an overhead

### BRIEF SUMMARY

The general purpose of the systems and methods disclosed herein is to provide an improved guitar carrying case. Specifically, the carrying case is a bag capable of carrying a guitar with the neck in the assembled position or in the disassembled position. The bag comprises a modular padded neck compartment which may be detachable and selectively coupled on the side of the bag without disconnecting the guitar strings. Alternatively the bag has a collapsible neck portion extending from the main cavity which can be extended to enclose the assembled guitar.

### BRIEF DESCRIPTION OF THE DRAWINGS

In order to describe the manner in which the advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 shows a detailed plan view of the of the bag.

FIG. 2 shows a perspective view of the bag with the cavity exposed.

FIG. 3 shows a plan view of the bag in a first configuration with the cover exposing the cavity.

FIG. 4 shows a plan view of the bag in a second an embodiment of the invention.

FIG. 5 shows a top perspective view.

FIG. 6 shows a perspective view of the bag in the second configuration with the cover open.

FIG. 7 shows a perspective view of the bag transitioning from the first configuration to the second configuration with the cover open.

FIG. 8 shows a perspective view of the back of the bag.

FIG. 9 shows a plan view of the case with an assembled guitar in the cavity, the bag in the first configuration.

FIG. 10 shows perspective view of the body of a disassembled guitar with the bag in the second configuration.

FIG. 11A shows a plan view of the bag in the second configuration.

FIG. 11 B shows a plan view of the bag in the second configuration with the padded neck sleeve valve open showing the neck of a disassembled guitar.

FIG. 12 A shows the padded neck sleeve separated from the main bag.

FIG. 12 B shows the padded neck sleeve with the valves in the open position, the sleeve receiving the neck of an assembled guitar.

FIG. 13 A shows a perspective view of the bag in the second configuration with the guitar wires extending from the body of the guitar in the main cavity to the neck of the guitar in the padded sleeve.

FIG. 13 B shows the bag in the first configuration being worn as a back pack.

FIG. 14 A shows the bag in a first configuration with a rain bag.

FIG. 14 B shows the bag in the second configuration with the rain bag.

### DETAILED DESCRIPTION OF THE INVENTION

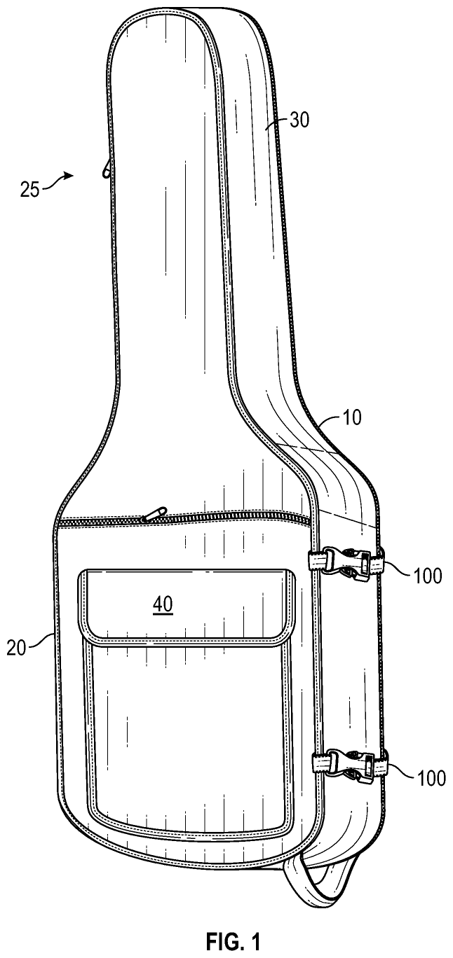

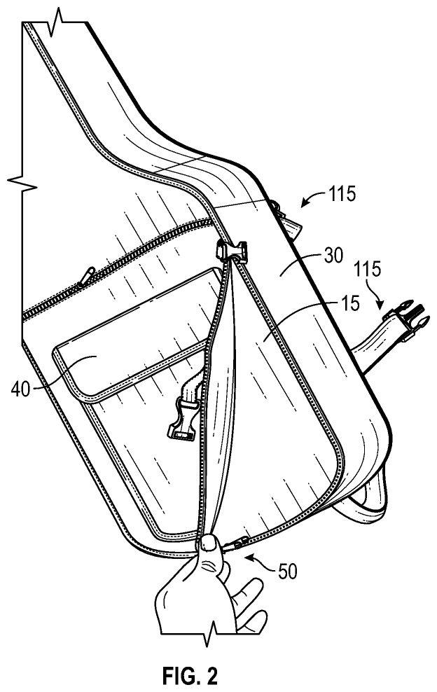

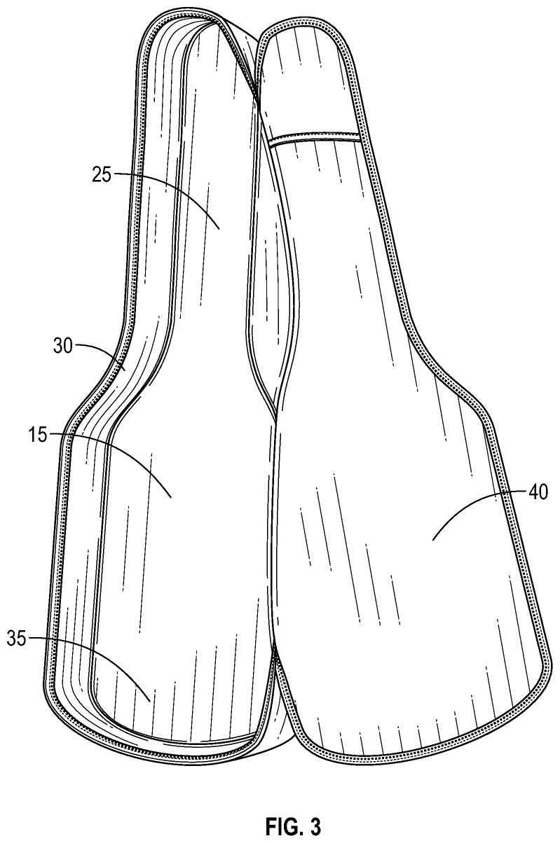

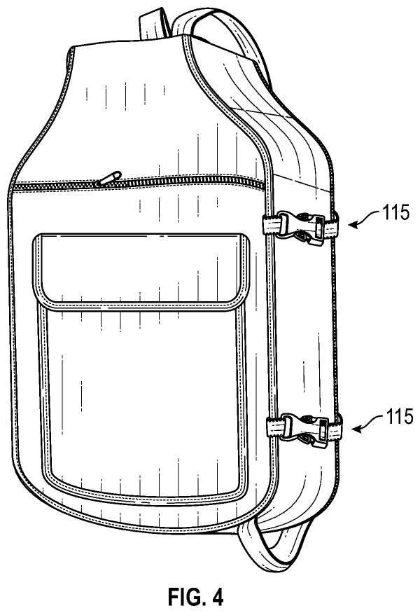

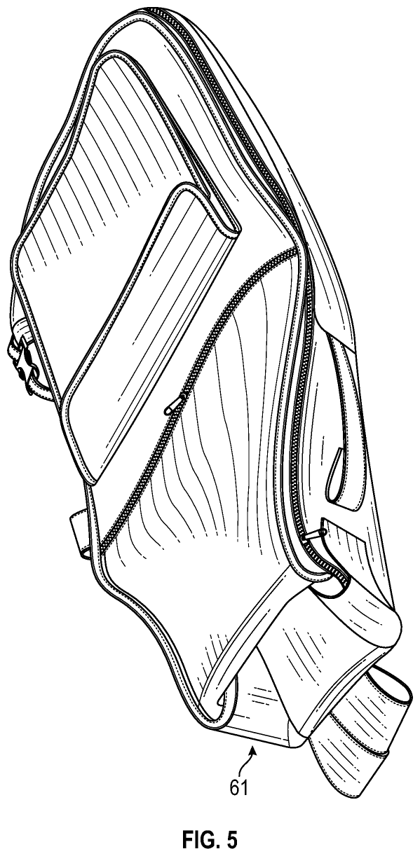

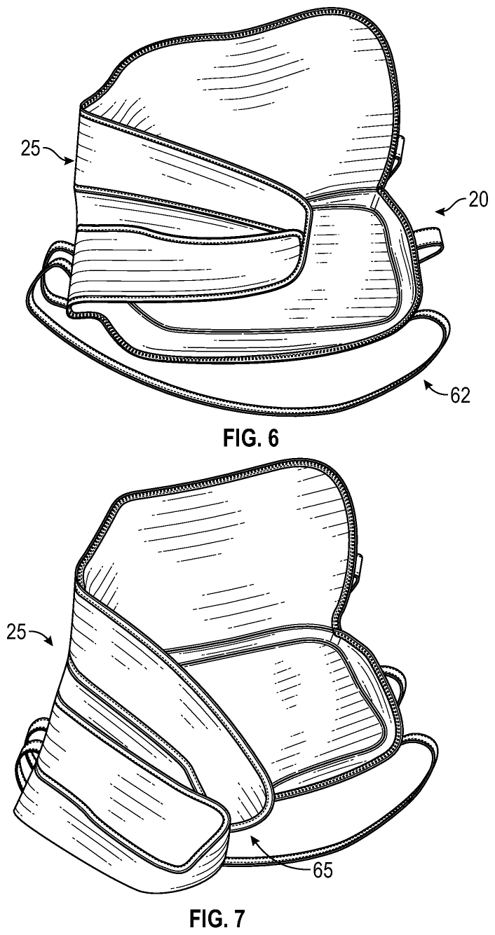

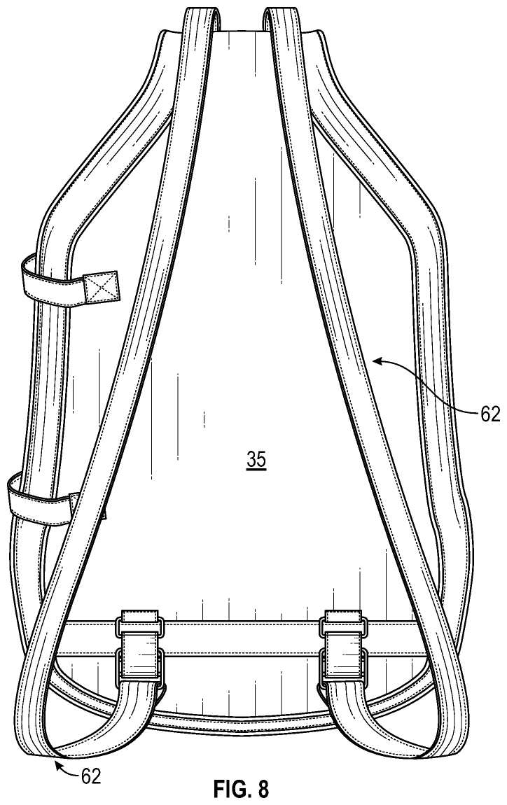

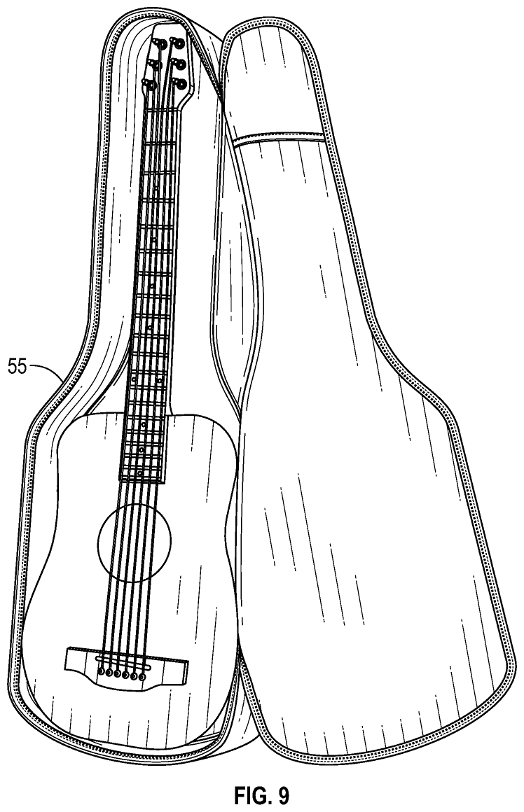

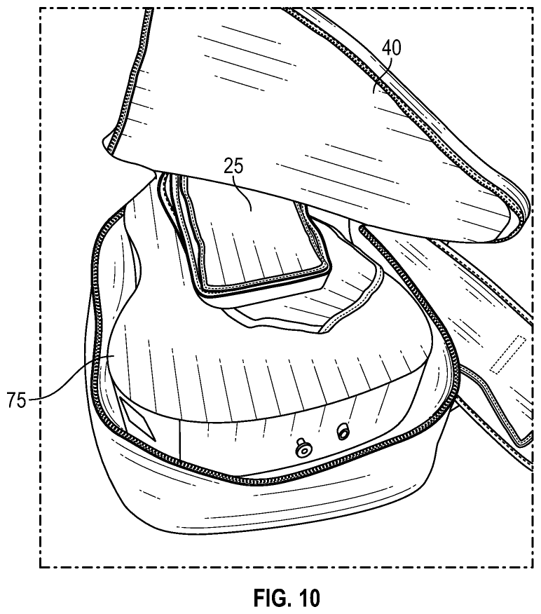

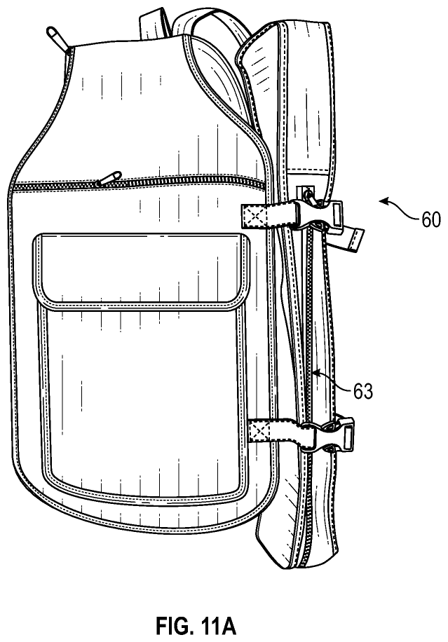

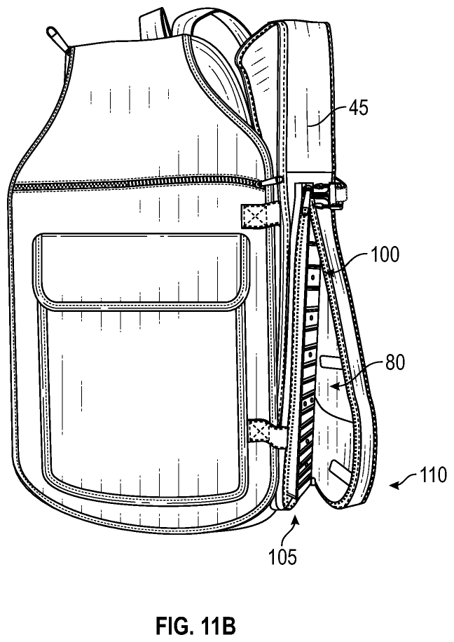

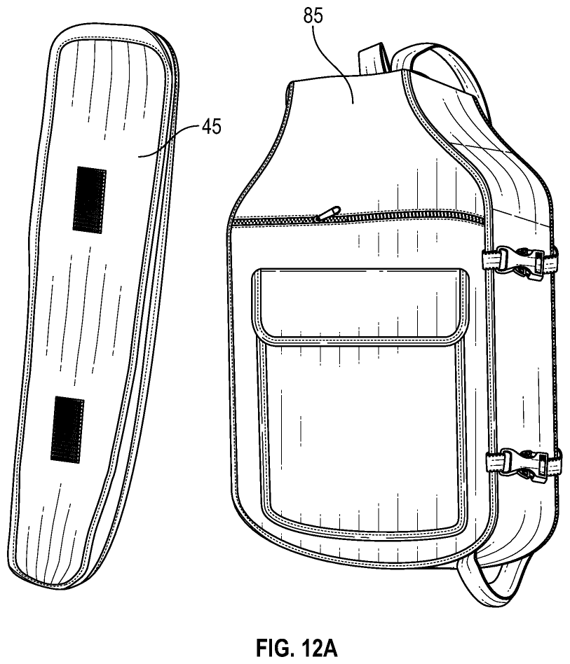

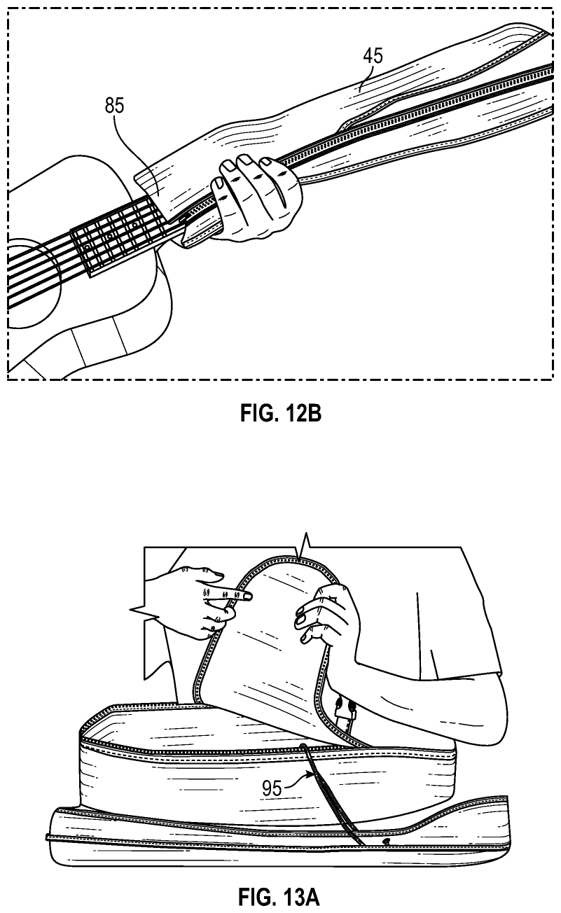

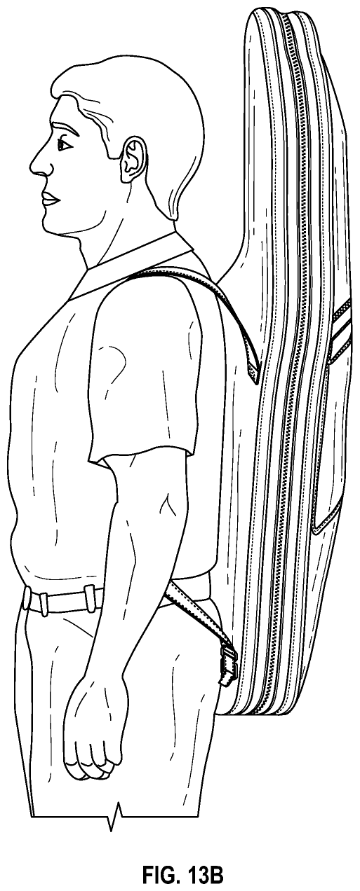

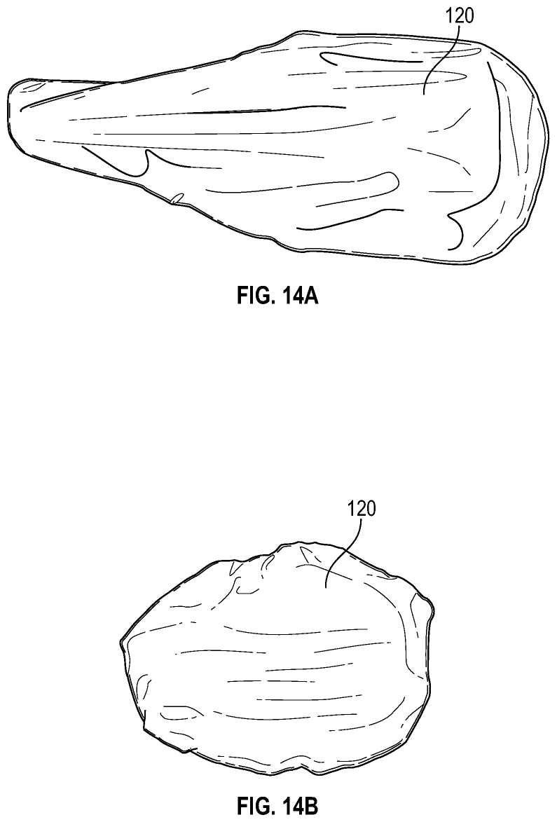

The present embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed descriptions of the embodiments of the apparatus, as represented in FIGS. 1-14 Bare not intended to limit the scope of the invention, as claimed, but are merely representative of alternative embodiments of the invention.

In general, a collapsible guitar carrying case 10 is disclosed. In some embodiments the bag comprises a cavity having a main portion and a neck portion 25 a side 30 and a bottom 35 wherein the neck portion 25 is narrower than the main portion. in some embodiments the main portion is tailored in the shape of a dreadnaught. In some embodiments the main portion is sized for full sized guitar. In some embodiments the main portion is sized for a travel size sized guitar which his smaller than a full size guitar. In some embodiments the bottom 35 and side portions 30 form a receiving portion into which an assembled guitar can be placed.

The bag further comprises a cavity cover 40 which is connected to a portion of the side 30 to allow the cover 40 to flap open in a clamshell-like fashion. In some embodiments at least one of the bottom 35, side 30 and cover 40 is padded. In some embodiments the bottom 35 side and cover 40 are made from a duffle-type soft material such as a cloth, Cordura®, rayon, nylon, Kevlar®, leather, or plant fiber materials such as industrial hemp. In some embodiments the cavity 15 is lined with a non-abrasive material to avoid scratching the body 75 of the guitar.

The bag further comprises a coupling mechanism 50. In some embodiments the coupling mechanism 50 allows the bag to selectively couple the cover 40 to the side 30 to close the bag. In some embodiments the coupling mechanism 50 may comprise a zipper, a magnetic strip, buckles, clasps, hook and loop such as Velcro®, straps or a combination of the which permits the cover 40 to selectively couple to the side 30 to close.

In some embodiments when the coupling mechanism 50 a zipper the mechanism comprises a plurality of slider bodies, the portion of the zipper which mechanically engages the zipper teeth or chain. In some embodiments a first slider body is positioned at the distal end of the mechanism at the end of the neck portion 25. In some embodiments a second slider body is positioned proximal the first slider body along the sipper chain so as to engage the zipper chain in a closed position as the slider body is moved distally toward the first slider body, such that when the first and second slider bodies meet the zipper is in an engaged or closed position. A third slider body is provided on the proximal end opposite the first slider body, so the second slider body is positioned between the first and third slider bodies. The third slider body is oriented on the chain so as to engage or close the chain when it is pulled away from the second slider body, and open or disengage the chain when positioned next to the second slider body. The configuration of the second and third slider bodies allows the main cavity 15 to be accessed from the bottom 35 of the bag while the neck portion of the cavity 25 is engaged. In some embodiments, when the neck portion 25 is collapsed into the main cavity 15 of the body 75, the first and second slider bodies are configured together and the third slider body is manipulated to open the bottom portion of the cavity, allowing a disassembled guitar body 75 to be placed into the main portion. In some embodiments as the third slider body is manipulated proximally away from the second slider body, thus engaging the teeth and closing the zipper, the terminal of the zipper is adjacent neck pad coupling mechanisms. In some embodiments, such as when a complete guitar is disassembled and the body 75 is placed into the main cavity 15 receiving portion, and the neck 80 is placed into the padded neck sleeve 45, the wires are remain connected to the neck 80 and the bridge. Thus the position of the third slider body is pushed to the end of the zipper, allowing the wires to pass through an opening in the closing mechanism and into adjacent the padded neck sleeve 45. This configuration permits the disassembled guitar to be easily selectively reassembled.

The neck portion 25 of the bag is the long slender portion extending from the main receiving portion configured to enclose the neck of a guitar when the guitar is assembled. Housing the assembled guitar is the first configuration 55 of the neck portion 25. In certain alternative embodiments a second configuration 60 comprises receiving the bod of a disassembled guitar wherein the neck is removed from the body 75 of the guitar, leaving the neck portion of the cavity 25 empty thus allowing the collapsible neck portion 25 to collapse and fold into the main receiving portion of the cavity. This second configuration, the neck portion 25 folded into the main cavity 15, substantially reduces the size of the bag, making it easier to stow, especially on an airplane.

In certain embodiments the closing mechanism extends distally along a first side 30 of the neck portion 25, along a second side 30 of the neck portion 25 and along part of the third side 30 of the neck portion 25. In certain embodiments where the closing mechanism is a zipper, the first sliding body is positioned at the extreme distal end of the zipper while the second sliding body is positioned on the opposite side 30 of the neck, approximately at the base of the neck. This positioning of the first slide body and second slide body allow neck portion 25 of the cavity to be turned inside out and collapsed so as to lie flat when it is folded into the main portion of the cavity 15 in the second configuration. In certain embodiments the folded neck portion 25 in the second configuration the second slide body is positioned at the fold, which marks the top of the bag in the second configuration. Moreover, in certain embodiments the folded-in neck portion 25 in the second configuration leaves an opening in the side of the bag which is filled or blocked by the collapsed neck portion 25.

In certain embodiments the bag further comprises shoulder straps 62 which are attached to the outside surface of the bottom portion of the main cavity 15. The shoulder straps 62 are coupled to the bag using sewing, buttons, clasps, hook and loop, zippers, latches or similar coupling mechanisms. In certain configurations the distal ends of the straps 62 are coupled to the bottom at approximately the fold line, to preserve the functionality of the straps 62 when the bag is in either a first configuration or a second configuration. The proximal ends of the straps 62 are coupled to an edge of the bottom. In certain embodiments the bag further comprises a handle on the exterior of the bag. In certain embodiments the bag further comprises a plurality of pockets on the exterior surface of the cover 40. The pockets are configured to receive personal effects such as music, a laptop computer and the like.

In certain embodiments a seam is placed connecting the side 30 to either the cover 40 or the back proximal the edge of the material, so the material distal the seam is bound into a grow 63. The grow 63 provides a lip that extends beyond the seam. In some embodiments the grow 63 is cosmetic, while in other embodiments the grow 63 is functional, as will be discussed in greater detail below.

In certain embodiments the bag further comprises additional side coupling mechanisms, such as straps 62 and buckles on the side 30 of the bag adjacent the terminal position of the third slide body.

In certain embodiments the bottom, side 30 and cover 40 contain padding to protect the guitar. The padding may comprise foam, heavy duty bubble wrap or air bladders. The volume of the foam in the neck portion 25 is thin enough to allow the neck portion 25 to fold on itself in the second configuration. The padded neck sleeve 45 also provides a coupling members on the exterior of the sleeve 45 through which the side 30 coupling mechanisms can selectively pass to secure the padded neck sleeve 45 to the exterior of the bag.

In certain embodiments the further comprises a padded neck sleeve 45 wherein the sleeve is configured to receive a neck of a guitar disassembled from the body 75 of the guitar. In certain embodiments the neck sleeve 45 comprises a front, a back and a side portion made of a duffle-type flexible materials and may further comprise a padding layer. In certain embodiments the sleeve 45 comprises a closing mechanism. In certain embodiments the closing mechanism is a zipper which is disposed in the side portion, splitting the side portion in two, wherein the closing mechanism wraps around a plurality of faces of the padded neck sleeve 45 sides. In certain embodiments the closing mechanism comprises a first slide body and a second slide body which open the closing mechanism when positioned on opposite ends of the zipper to form a valve-like opening at one end of the sleeve 45. In certain embodiments a retaining members 115, such as a hook and loop system, snaps, hook and catch, magnets, or button and hole, to selectively secure the respective sides of the valve leaflets 105, 110 folded inside the sleeve 45 in an open position. In an alternative embodiment the retaining members 115 may be on the outside of the sleeve. The open-valve configuration may be used to protect the neck on an assembled guitar. In certain embodiments the neck sleeve 45 with the valve 105, 110 in the open position will protect the neck when used independent of the bag.

In certain embodiments the closing mechanism of the padded neck sleeve 45 can be closed to secure a neck of a disassembled instrument, such as a guitar. In certain embodiments, when a neck of a disassembled guitar is enclosed in the sleeve 45 the wires will extend from the sleeve's 45 closing mechanism through the bag's closing mechanism and to the body 75 of the disassembled guitar. The grow on both the bag and the sleeve 45 over laps when the padded neck sleeve 45 is secured to the bag, protecting and concealing the wires passing from the padded neck sleeve 45 to the body 75.

In certain embodiments the bag further comprises a rain cover 120 tailored to securely fit on the bag in either the first configuration or the second configuration. In some embodiments the hem of the rain cover 120 comprises an elastic band which is stretched to receive the bag and then allowed to contract to snugly fit over the bag. In some embodiments the rain cover is made from a combination of water proof, water resistant material or ultra violet resistant materials. In certain embodiments the rain cover 120 is separate from the bag, while in other embodiments the rain cover is integrated into the bag and can be stuffed into a flap or pocket while not in use.

In closing, it is to be understood that the embodiments of the disclosure disclosed herein are illustrative of the principles of the present disclosure. Other modifications that may be employed are within the scope of the disclosure. Thus, by way of example, but not of limitation, alternative configurations of the present disclosure may be utilized in accordance with the teachings herein. Accordingly, the present disclosure is not limited to that precisely as shown and described.

1. A collapsible guitar carrying case comprising:
a cavity having main portion and a neck portion a side and a bottom wherein the neck portion is narrower than the main portion;
a cavity cover;
a padded neck sleeve;
a coupling mechanism which permits the cover to selectively couple to the side to close the cavity; and
wherein the collapsible neck portion and corresponding cavity cover can be configured in a first extend configuration to receive an assembled guitar and a second collapsed configuration wherein the collapsible neck portion is collapsed and concealed into the main cavity.

2. The collapsible guitar carrying case of claim 1 wherein the entire case is a duffle-type bag.

3. The main cavity of claim 1 wherein the main cavity is configured to receive a body of a guitar without a guitar neck while the neck portion is collapsed into the main cavity.

4. The padded neck sleeve of claim 1 wherein the sleeve is configured to receive a neck of a guitar disassembled from the body of the guitar.

5. The padded neck sleeve of claim 1 wherein the sleeve is selectively separable from the collapsible guitar carrying case.

6. The padded neck sleeve of claim 1 wherein the sleeve is selectively separable from the collapsible guitar carrying case and configured to enclose the neck of a guitar separated from the body of the guitar while the guitar strings are still attached.

7. The padded neck sleeve of claim 1 further comprising coupling members to selectively enclose and protect a disassembled guitar neck.

8. The padded neck sleeve of claim 1 wherein a first end of the sleeve comprises a valve, wherein a selective retaining members configured to retain the valve in an open position so as to protect the neck of a guitar in an assembled configuration.

9. The collapsible guitar carrying case of claim 1 wherein the coupling mechanism permits the cover to be selectively and intermittently coupled to the side in discrete locations so as to access the main cavity without opening the entire coupling mechanism.

10. A collapsible guitar carrying case further comprising a rain cover.

11. A method of providing a collapsible guitar carrying case comprising:
providing a cavity having main portion and a neck portion a side and a bottom wherein the neck portion is narrower than the main portion;
providing a cavity cover;
providing a padded neck sleeve;
providing a coupling mechanism which permits the cover to selectively couple to the side to close the cavity; and
wherein the collapsible neck portion and corresponding cavity cover can be configured in a first extend position to receive an assembled guitar and a second collapsed configuration wherein the collapsible neck portion is collapsed and concealed into the main cavity.

12. The method of main cavity of claim 11 further comprising placing the body of a disassembled guitar into the main portion of the cavity and collapsing the neck portion of the cavity into the main portion of the cavity.

13. The method of claim 11 further comprising placing a disassembled neck of a guitar into the padded neck sleeve without detaching the guitar strings from the body.

14. The method of claim 11 further comprising selectively coupling the padded neck sleeve to the outside of the collapsible bag.

15. The method of claim 11 wherein the padded neck sleeve wherein a first end of the sleeve comprises a valve, wherein a selective retaining members configured to retain the valve in an open position so as to protect the neck of a guitar while the guitar is in an assembled configuration.

16. The method of claim 11 further comprises a selectively and intermittently coupling the coupling mechanism to the side in discrete positions so as to access the main cavity without opening the entire coupling mechanism.
